(19) United States
(12) Patent Application Publication
(10) Pub. No.: US 2026/0036603 A1
(43) Pub. Date: Feb. 5, 2026

(54) WHEEL SPEED SCALER FOR VEHICLES

(71) Applicant: DirectDrive Plus, LLC, Honey Brook, PA (US)

(72) Inventor: Duane Martin, New Holland, PA (US)

(73) Assignee: DirectDrive Plus, LLC, Honey Brook, PA (US)

(21) Appl. No.: 19/277,077

(22) Filed: Jul. 22, 2025

Related U.S. Application Data
(60) Provisional application No. 63/677,158, filed on Jul. 30, 2024.

(51) Int. Cl. G01P 3/489; B60K 35/28; B60T 8/171; G01P 3/488

(52) U.S. Cl. CPC G01P 3/489; B60K 35/28; G01P 3/488; B60K 2360/167; B60T 8/171; B60T 2240/00; B60T 2250/04; B60T 2260/00; B60T 2270/10

(57) ABSTRACT

A speed scaler adjusts the electronic signals received from the electronic speed sensor on a vehicle to reflect the actual speed of operation of a vehicle after replacement tires are installed on the vehicle. The dimensional parameters of the original tires and the replacement tires for the vehicle are stored in the memory of the speed scaler system and compared to create a ratio for adjustment. The speed scaler is operatively positioned between the electronic speed sensor which creates an electronic pulse corresponding to the rotational speed of each wheel. The speed scaler intercepts these electronic pulses and adjusts the timing of the pulses in accordance with the ratio of the original tire circumference and the replacement tire circumference, and then transmits the adjusted electronic pulse to the Anti-Lock Brake System for re-transmission to the components of the vehicle requiring accurate vehicle speed indications.

### CROSS-REFERENCE TO RELATED APPLICATIONS

This application claims domestic priority to U.S. Provisional Patent Application Ser. No. 63/677,158, filed on Jul. 30, 2024, the content of which is incorporated herein by reference.

### FIELD OF THE INVENTION

The present invention relates generally to the determination of the operating speed of a vehicle, and, more particularly, to the scaling of the vehicle speed display when tires and/or wheels having a larger or smaller diameter than is the standard diameter for that vehicle.

### BACKGROUND OF THE INVENTION

Modern vehicles have multiple electronic modules that control various vehicle functions. These electronic modules communicate on a CAN Bus network. The operating speed of the vehicle is computed by sensors at each wheel sensing a tone ring having evenly spaced teeth circumferentially disposed around the tone ring. The sensor created a pulse corresponding to passing of each tooth on the tone ring. These pulses are fed into the Anti-lock Brake System (ABS) module, which calculates the operating speed of the vehicle based on the lapsed time between pulses, taking into account the number of pulses per revolution and the circumference of the tire. The operating speed of the vehicle is then transmitted across the CAN bus network to the various modules needing the operating speed of the vehicle for proper function.

When larger tires are installed on the vehicle without changing value of the tire circumference recorded in the Anti-lock Brake Module, the indicated operating speed of the vehicle is incorrect. Then, other electronic modules needing accurate vehicle operating speed are provided with the incorrect operating speed which alters the proper functionality of these other electronic modules. In addition, errors are displayed on the instrument cluster when vehicle forces are outside the expected parameters for the indicated operating speed. Functions such as emergency braking, traction control, or Anti-lock Brake Systems may be disabled because of the transmitted operating speed error.

Vehicles are known to incorporate speed sensing apparatus, including a tone ring and a ferrous sensor that sense the number of pulses during the rotation of the wheel of the vehicle and, based on the diameter of the tire, calculate the speed for the standard tire size used on the subject vehicle. However, original equipment manufacturers (OEM) do not provide a way to change the tire circumference in the Anti-lock Brake Module to compensate for the installation of larger diameter tires that have a longer circumference. An attempt to compensate for tire size changes is disclosed in U.S. Patent Publication No. 2023/0243862, published on Aug. 3, 2023, by Skeeter Brush Trucks, LLC, in which calculations are made to define a ratio of the pulses generated by the speed sensor and allow the position of the speed sensor to be adjusted to a location near the tone ring correlating to the calculated ratio.

Accordingly, it would be desirable to provide an apparatus that would compensate for the change in tire circumference when tires that are either smaller or larger than the standard tires for that particular vehicle are installed so that accurate operating speeds are transmitted to the Anti-lock Braking System and other electronic modules requiring accurate vehicle operating speed for proper functionality.

### SUMMARY OF THE INVENTION

It is an object of this invention to overcome the disadvantages of the prior art by providing a wheel speed scaler for vehicles.

It is another object of this invention to provide a speed scaler that intercepts and revises electronic signals from an electronic sensor before being transmitted to an Anti-Lock Brake System of the vehicle.

It is a feature of this invention that the speed scaler compares the timing of pulses from the electronic sensor with the stored timing of the electronic pulses corresponding to the original tires for the vehicle.

It is an advantage of this invention that the timing of the electronic pulses are adjusted according to the ratio of the replacement tires relative to the original tires to provide a corrected electronic pulse to the Anti-Lock Brake System of the vehicle.

It is another advantage of this invention that the corrected electronic pulse transmitted to the Anti-Lock Brake System is representative of the actual speed of operation of the vehicle.

It is another feature of this invention that the Anti-Lock Brake System calculates the actual speed of operation of the vehicle from the corrected electronic signals and transmits the operation speed to other components of the vehicle that require accurate speed of operation to perform the function of the vehicle component.

It is still another feature of this invention that the Speed Scaler System is operatively positioned between the electronic speed sensors and the Anti-Lock Brake System.

It is still another advantage of this invention that the Speed Scaler System intercepts the electronic signals from the sensor associated with the electronic speed detection apparatus and adjusts the timing of the electronic signals before transmitting the adjusted electronic signals to the Anti-Lock Brake System.

It is yet another advantage of this invention that the adjusted electronic signals received by the Anti-Lock Brake System from the Speed Scaler System accurately reflect the actual operational speed of the vehicle.

It is a further object of this invention to provide a speed adjustment system that is durable in construction and simple and effective in use.

These and other objects, features and advantages are accomplished according to the instant invention by providing a speed scaler that will adjust the electronic signals received from the electronic speed sensor on a vehicle to reflect the actual speed of operation of a vehicle after replacement tires are installed on the vehicle. The dimensional parameters of the original tires and the replacement tires for the vehicle are stored in the memory of the speed scaler system and compared to create a ratio for adjustment. The speed scaler is operatively positioned between the electronic speed sensor which creates an electronic pulse corresponding to the rotational speed of each wheel. The speed scaler intercepts these electronic pulses and adjusts the timing of the pulses in accordance with the ratio of the original tire circumference and the replacement tire circumference, and then transmits the adjusted electronic pulse to the Anti-Lock Brake System for re-transmission to the components of the vehicle requiring accurate speed indications.

### BRIEF DESCRIPTION OF THE DRA WINGS

The advantages of this invention will become apparent upon consideration of the following detailed disclosure of the invention, especially when taken in conjunction with the accompanying drawings wherein:

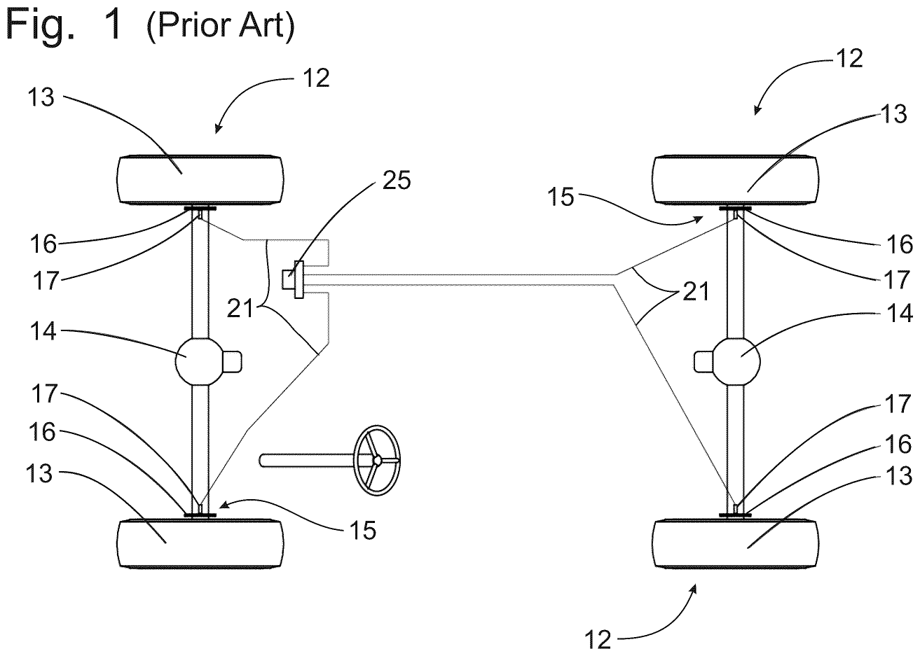

FIG. 1 is a schematic plan diagram of a vehicle showing the conventional arrangement of the wheel sensors of a four wheeled vehicle inputting pulse data from the speed sensors into the Anti-lock Brake Module for distribution to the other electronic control modules;

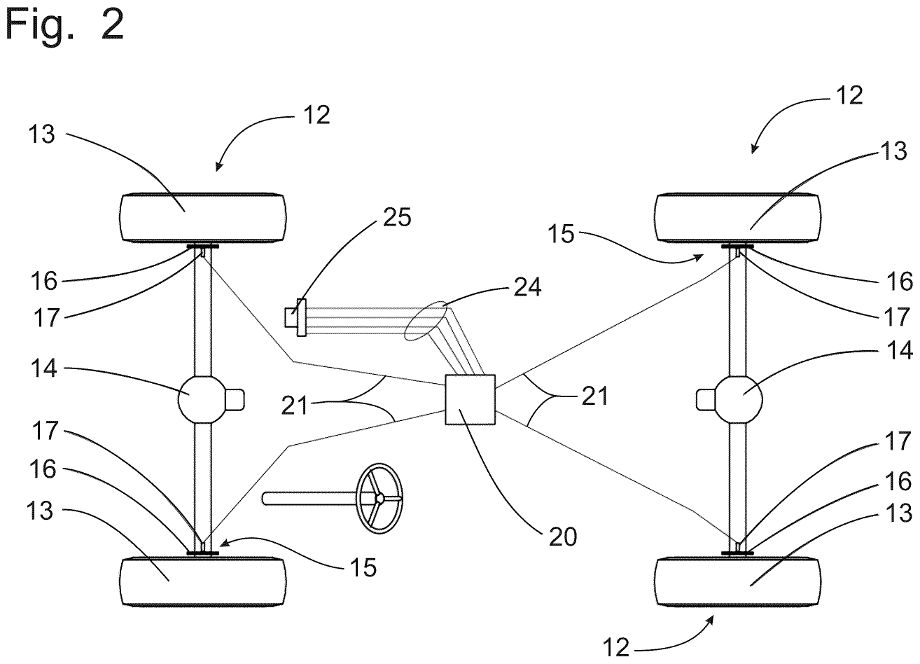

FIG. 2 is a schematic plan diagram of a four wheeled vehicle using the principles of the instant invention;

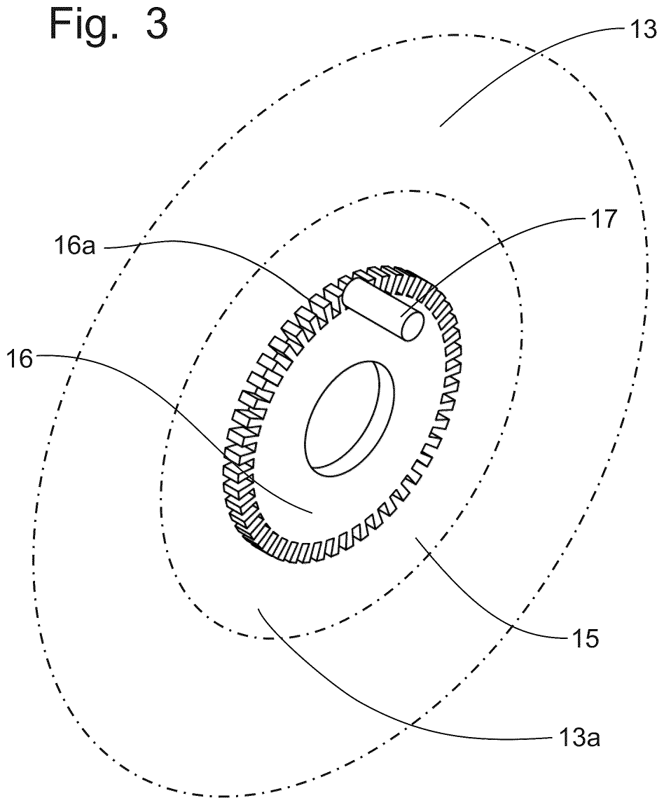

FIG. 3 is a schematic prospective view of the tone ring and sensor mounted on a representative wheel of the vehicle; and

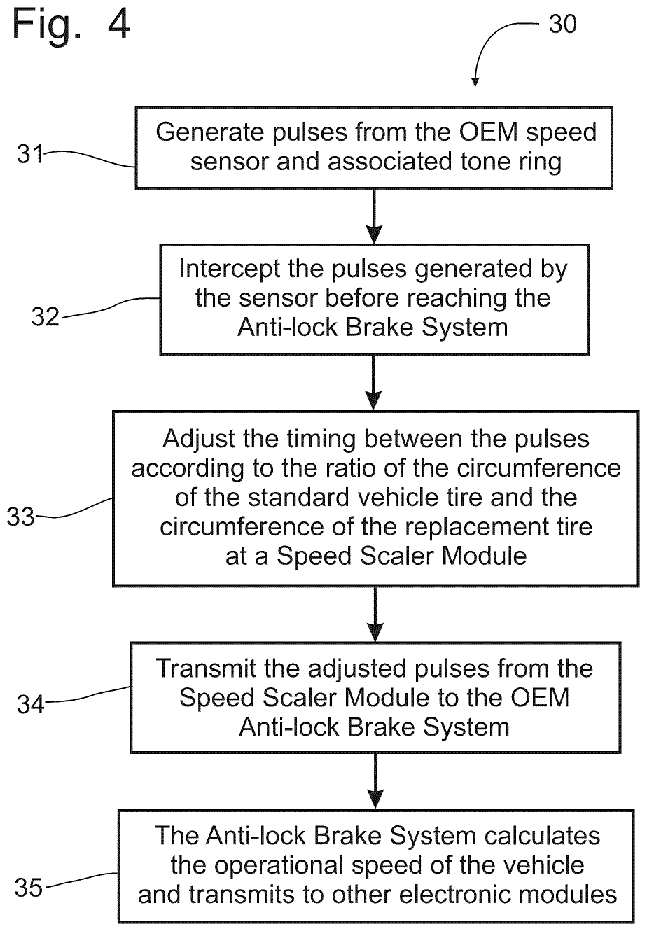

FIG. 4 is a logic flow diagram reflecting the method of adjusting and correcting the operational speed of a vehicle as a function of the size of the tires placed onto the vehicle.

### DETAILED DESCRIPTION OF THE PREFERRED EMBODIMENT

Referring to the drawings, a schematic representation of the instant invention can be seen. FIGS. 1 and 3 are schematic representations of the known prior art of sensing the speed of a vehicle and providing the sensed speed into the electronic module for the Anti-lock Brake System (ABS) from which further distributions of that sensed vehicle speed are sent to other electronic modules needing the speed of the vehicle to function, such as the speedometer display or traction control system. FIG. 2 depicts the improvement corresponding to the instant invention by providing a speed scaling module in operative communication between the wheel sensors and the Anti-lock Brake System.

The conventional vehicle 10 provided by the vehicle manufacturer has front and rear wheel assemblies 12 interconnected by axles 14. Each wheel assembly 12 is provided with a tone ring 16 mounted on each wheel 13a coupled with a sensor 17 that will generate an electronic signal as a tooth 16a on the tone ring 16 passes by the sensor 17. As the wheel assembly 12, including the wheel 13a and the tire 13 mounted thereon, rotates, the tone ring 16 mounted on the wheel 13a rotates with the wheel 13a, causing the teeth 16a on the tone ring 16 to pass by the stationary sensor 17, utilizing the principles of electromagnetic induction from the teeth 16a to result in an electrical pulse in the sensor 17 corresponding to each tooth 16a of the tone ring 16, separated by a gap between the teeth 16a, passing by the sensor 17. The electrical pulse from each wheel assembly 12 is conventionally transmitted to the Anti-lock Brake System 25 which computes the time between each electrical pulse and or counts the pulses to define the rotation of the tire 13.

The Anti-lock Brake System 25 has stored therein the number of teeth 16a formed on each tone ring 16, which is recorded in the Anti-lock brake module 25 along with the circumference of the standard tire and wheel assembly 12. The number of pulses, as well as the time between pulses, can be used to calculate how many revolutions per minute the tire and wheel assembly 12 are making. By a standard algorithm used to multiply the number of revolutions per minute with the length of the circumference of the tire and wheel assembly 12, the speed of the vehicle is conventionally computed by the Anti-lock Brake System and forwarded to the other electronic modules requiring the operational speed of the vehicle to properly function.

When larger tires and wheel assemblies 12 are installed on the vehicle in replacement of the standard sized tires, the vehicle travels further with the revolution of the wheels as the circumferential distance of the tire 13 is greater. Since the Anti-lock Brake System 25 calculates the vehicle speed based on a tire with a smaller circumference, an incorrect speed is derived. A similar error is also the result when tires smaller than the original standard tires are installed on the vehicle.

A Speed Scaler Module 20 is provided according to the principles of the instant invention to correct the sensed speed of the vehicle 10 by increasing or decreasing the time between pulses corresponding to the circumferential size of the replacement tire compared to the standard tire provided with the vehicle 10. As the tire and wheel assemblies rotate, the teeth 16a on the tone ring 16 rotate past the sensor 17, creating the aforementioned electrical pulse; wires 21 from the sensor 17 are routed to the Speed Scaler Module 20, rather than directly to the Anti-lock Brake System 25. Preferably, the Speed Scaler Module 20 stores a predetermined number of pulses in memory and then averages the time between pulses.

The Speed Scaler Module 20 generates pulses to be sent to the Anti-lock Brake System 25 that are increased or decreased with respect to the time between the pulses, according to the ratio of the standard tire circumferential distance to the circumferential distance of the replacement tire. To correct the vehicle speed, the time between electrical pulses must be shortened for larger tires or lengthened for smaller ones. The modified pulse is then sent from the Speed Scaler Module 20 directly to the Anti-lock Brake System Module 25 through wires 24. The Anti-lock Brake System 25 then calculates the time between the pulses, or the number of pulses for a given time period, as the Anti-lock Brake System 25 would normally do, to find the revolutions per minute and then multiplies this sum by the circumference of the original standard tire. Since the time between the pulses has been changed by Speed Scaler Module 20, either increasing or decreasing depending on the tire size, as opposed to the original tire and wheel assembly 12, the Anti-lock Brake System 25 broadcasts the correct vehicle speed to the electronic modules on the vehicle's computer network.

The corrected speed of the vehicle 10 is an adjustment performed by the Speed Scaler Module 20 without changing the operation of the speed sensor 17 and tone ring 16, or the operation of the Anti-lock Brake System 25 according to the method 30 shown in FIG. 4. The Original Equipment Manufacturer's (OEM) speed sensor 17 and associated tone ring 16 for each wheel 13a of the vehicle 10 generates the electronic pulse corresponding to each tooth 16a of the tone ring 16 passing by the sensor 17. These OEM generated pulses are transmitted toward the OEM Anti-lock Brake System 25, as reflected in Step 31. The Speed Scaler Module 20 intercepts the transmitted pulses generated by the OEM speed sensor 17 before reaching the OEM Anti-lock Brake System 25, as noted in Step 32.

The Speed Scaler Module 20 which is pre-programmed with the diameter and/or circumference of the standard OEM tires 13 provided by the vehicle manufacturer, which tire parameters are pre-programmed into the OEM Anti-lock Brake System 25, and with the diameter and/or circumference of the replacement tires 13 that have been mounted on the vehicle 10, for which the parameters of the replacement tires have been inputted to the Speed Scaler Module 20, the ratio of the two circumferences can be calculated or pre-programmed into the Speed Scaler Module 20. The Speed Scaler Module 20 then increases or decreases the timing between the transmitted pulses according to the ratio of the two circumferences, and generates substitute adjusted pulses at Step 33 that are then sent to the OEM Anti-lock Brake System 25, which receives the substitute adjusted pulses at Step 34 and calculates the speed of the vehicle therefrom at Step 35. The OEM Anti-lock Brake System 25 then distributes the corrected operational speed of the vehicle 10 to the various electronic modules.

It will be understood that changes in the details, materials, steps and arrangements of parts, which have been described and illustrated to explain the nature of the invention will occur to and may be made by those skilled in the art upon a reading of this disclosure within the principles of the scope of the invention. The foregoing description illustrates the preferred embodiment of the invention; however, concepts, as based upon the description may be employed in other embodiments without departing from the scope of the invention. Accordingly, the following claims are intended to protect the invention broadly, as well as in the specific form shown.

In the way of an example, the tone ring 16 could also be a rib/slot exciter ring (not shown) that will generate pulses corresponding to the sensing of the ribs separated by the slots. The speed sensor 17 could be an inductive magneto-restrictive sensor or a Hall Effect type sensor. Other known sensors and tone ring devices can be utilized, as well, to generate the pulses to be intercepted by the Speed Scaler Module according to the principles of the instant invention.

As another example, some vehicles have differently sized tires on the front of the vehicle as compared to the rear of the vehicle. The speed scaler system can identify which wheel the generated electronic pulses come from and adjust the electronic pulses according to the ratio of the original tire circumference relative to the replacement tire circumference, thus providing different substitute electronic pulses to the Anti-Lock Brake System with respect to the front wheels compared to the rear wheels. Accordingly, one of ordinary skill in the art will note that FIG. 2 the speed scaler module 20 is receiving electronic pulse signals from all four wheels of the vehicle. One of ordinary skill in the art will also recognize that the vehicles schematically depicted in the drawings are four wheel vehicles, but could also be a vehicle having three or more axles with an electronic sensor mounted on each end of each axle.

Having thus described the invention, what is claimed is:

1. An apparatus for correcting vehicle operational speed as a function of the size of the tires mounted on the vehicle, comprising:
a speed measuring device associated with one or more selected wheels of said vehicle, each said speed measuring device being operable to generate electronic pulses representative of the rotational speed of the associated wheel;
an electronic module including a processor that functions to receive electronic pulses representative of the rotational speed of said one or more selected vehicle wheels; and
a speed scaler module supported on said vehicle and being operationally positioned between said one or more speed measuring devices and said electronic module such that said speed scaler module receives the generated electronic pulses from said one or more speed measuring devices representative of the rotational speed of each associated wheel, said speed scaler module adjusts the timing of the generated electronic pulses according to a ratio of a circumference parameter of the original tires programmed into the electronic module and a circumference parameter of replacement tires mounted on the vehicle to create a substitute electronic pulses which are transmitted to the electronic module to represent a corrected operational speed of said vehicle.

2. The apparatus of claim 1 wherein said speed measuring device includes a device formed with a plurality of equally spaced signal producing members, said device being secured to the associated wheel for rotation therewith and an adjacent stationary sensor that generates said electronic pulse in response to each respective signal producing member passing by said sensor.

3. The apparatus of claim 2 wherein each said signal producing member is a ferrous member that causes an induced electronic pulse from said sensor for the passage of each member.

4. The apparatus of claim 3 wherein each said sensor induces an electromagnetic signal for each ferrous member passing said sensor.

5. The apparatus of claim 1 wherein said electronic module is an Anti-lock Brake System for said vehicle.

6. The apparatus of claim 5 wherein said Anti-Lock Brake System calculates the operational speed of said vehicle from the substitute electronic pulses transmitted from said speed scaler module.

7. The apparatus of claim 6 wherein said Anti-Lock Brake System transmits to various components of said vehicle the calculated operational speed of said vehicle.

8. A method of correcting the operational speed indication of a vehicle when replacement tires are mounted on the vehicle which are differently sized with respect to original tires recommended for the vehicle, comprising the steps of:
generating electronic pulses from a speed measuring device mounted on at least one wheel of said vehicle, said electronic pulses having a timing parameter between consecutive pulses;
intercepting said electronic pulses generated by said speed measuring device by a speed scaler module that is pre-programmed with dimensional parameters relating to the original tires and said differently sized replacement tires, from which a ratio of the circumference of said standard tires relative to said replacement tires can be generated and/or stored;
adjusting the timing between said electronic pulses according to the ratio of the circumferences of the original tires relative to the replacement tires; and
generating substitute electronic pulses incorporating the adjusted timing between said electronic pulses, and transmitting said substitute electronic pulses to an electronic module for calculation of the actual operational speed of the vehicle and transmission of the actual operational speed of the vehicle to associated electronic modules requiring accurate operational speed data.

9. The method of claim 8 wherein said associated electronic modules includes a speedometer display.

10. The method of claim 8 wherein said speed scaler creates a ratio of the original tire circumference relative to the replacement tire circumference for each replacement tire placed onto said vehicle.

11. In a vehicle have tires supporting the vehicle on the ground, a speed detection system associated with at least one tire to record the rate of revolution of said at least one tire and to produce a signal in the form of electronic pulses, and an anti-lock brake system operable to convert the electronic pulses into an indication of speed of the vehicle and to transmit the indication of speed to components of said vehicle needing to know the vehicle speed to properly operate, the improvement comprising:
a speed scaler apparatus operatively positioned between the speed detection system and the anti-lock brake system to receive the electronic pulses from the speed detection system and adjust the time between pulses according to a comparison of parameters of original tires stored in the speed scaler and parameters of replacement tires placed on the vehicle.

12. The vehicle of claim 11 wherein said speed scaler apparatus transmits adjusted pulses to said anti-lock brake system from which the anti-lock brake system calculates actual vehicle speed using parameters of the original tires placed on the vehicle.

13. The vehicle of claim 12 wherein said parameters include the circumference of the respective tires.

14. The vehicle of claim 12 wherein each tire on said vehicle has associated therewith one of said speed detection systems, all of said speed detection systems sending electronic pulses to said speed scaler apparatus.
